(19) United States
(12) Patent Application Publication
(10) Pub. No.: US 2010/0288419 A1
(43) Pub. Date: Nov. 18, 2010

(54) METHOD AND DEVICE FOR ORIENTING THE ROTATIONAL POSITION OF CONTAINERS, IN PARTICULAR OF BOTTLES

(75) Inventor: Anton Niedermeier, Offenstetten (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/770,906

(22) Filed: Apr. 30, 2010

(30) Foreign Application Priority Data
May 12, 2009 (DE) 102009020936.0

(51) Int. Cl. B32B 37/12; G06F 7/00

(52) U.S. Cl. 156/64; 700/213; 156/378

(57) ABSTRACT

A method and a device for orienting the rotational position of containers, in particular bottles, wherein or by means of which a feature on the container is detected and an actual rotational position of the container is calculated on the basis of the detected feature and a control signal for moving the container to a desired rotational position is calculated, while the container is being rotated. The method and device reduce the time required for the orientation of the containers.

### CROSS-REFERENCE TO RELATED APPLICATION

The present application claims the benefit of priority of German Application No. 102009020936.0, filed May 12, 2009. The entire text of the priority application is incorporated herein by reference in its entirety.

### FIELD OF THE DISCLOSURE

The disclosure relates to a method and a device for orienting the rotational position of containers, in particular bottles.

### BACKGROUND

The rotational position of containers must be oriented e.g. in labeling machines before the containers are labeled, e.g. to ensure that a molding seam is sufficiently spaced apart from the label and/or that the label is positioned correctly with respect to a glass embossing.

In this respect, it is known from EP 1 205 388 B2 to detect the surface area of the container across its complete periphery by means of four imaging sensors, to analyze suited features in the taken pictures and to send commands to the drive system for the respective shortest rotation of the container about its longitudinal axis to reach a desired position. As a change of direction is possibly required for doing so, the rotation of the containers is first stopped after the image analysis, before the container can be finally moved to the desired position.

JP 4-367432 also describes a method wherein a feature on a rotating container is detected by analyzing video signals, wherein the rotation of the container is first stopped before it is moved to the desired position, and the container is transferred to a separate drive unit to this end.

### SUMMARY OF THE DISCLOSURE

Starting from prior art, it is desired to reduce the time required for the orientation of containers. In the orientation of a continuous stream of containers, the required space would then also be reduced, e.g. the number of machine divisions required for the orientation. It is an aspect of the disclosure to provide a correspondingly improved method.

This aspect is achieved in that steps b) to d), in which a feature on the container is detected, an actual rotational position of the container is calculated on the basis of the detected feature, and a control signal for moving the container to a desired rotational position is calculated, are carried out during step a), in which a container to be oriented is rotated. By a control signal for moving the container to a desired rotational position being already calculated and output during the motor operation, a deceleration ramp and an acceleration ramp can be eliminated and the container can be quickly moved to the desired rotational position.

Preferably, the container is rotated without interruptions in steps a) to e) until it reaches the desired rotational position. By avoiding a standstill before the desired position is reached, slip in the drive is avoided, thereby improving the accuracy of the orientation.

In a preferred embodiment, the rotation of the container is stopped in the desired rotational position. Thereby, the timing, in particular the start of a subsequent production step, can be designed flexibly.

Preferably, the container is rotated about its main axis. This facilitates the detection of a feature on the container surface characteristic of an actual rotational position.

It is furthermore advantageous for the container to be rotated in step e) at essentially the same angular velocity as in step a) until it reaches a deceleration ramp. This reduces the number of the required acceleration ramps and thus the energy consumption for the orientation of a container.

However, it can also be advantageous to rotate the container in step e) at least temporarily at a higher angular velocity than in step a). Thereby, the time required for moving the container to the desired rotational position and thus the total expenditure of time for the orientation of the container can be further reduced.

In one advantageous embodiment, the angular velocity in step e) is adapted to a rotational position correction angle. Thereby, the time required for moving the container to the desired rotational position can be standardized, even if the difference between the actual rotational position and the desired rotational position highly deviates with individual containers. This permits to save time as well as energy.

Preferably, the feature on the container is detected by imaging. An actual rotational position can thereby be detected flexibly and without contact.

In a particularly advantageous embodiment, the container is moved along a transport path during steps a) to e). Thereby, containers can be oriented in a continuous stream of containers.

Advantageously, steps a) to e) for orienting the containers are part of a method for labeling containers, wherein the containers are labeled in an additional step g).

In one advantageous embodiment of the method for labeling the containers, the rotational position of the container is readjusted in a step f) inserted between steps e) and g).

The technical problem is also solved by a device for orienting the rotational position of containers, wherein the control unit is designed such that it calculates and outputs a control signal for moving the container to a desired rotational position while the motor is operated. In this manner, a deceleration ramp and an acceleration ramp can be eliminated and the container can be quickly moved to the desired rotational position.

Preferably, the motor is a servomotor. This permits a simple and accurate movement to the desired rotational position.

A particularly advantageous embodiment of the device furthermore comprises a transport means which moves the container along a predetermined transport path during the orientation of its rotational position. Thereby, a continuous stream of containers can be oriented.

The technical problem is also solved by a labeling machine comprising the device according to the disclosure.

### BRIEF DESCRIPTION OF THE DRAWING

One preferred embodiment of the disclosure is shown in the drawing and will be illustrated below.

The single FIGURE shows a time diagram of a method according to the disclosure and the pertaining course of the rotational speed ω of a container 1 to be oriented with time t.

### DETAILED DESCRIPTION OF THE PREFERRED EMBODIMENT

As can be seen in the FIGURE, during a procedure step a), a container 1, such as a bottle, is rotated on a support 3, such as a rotary table, driven by a (non-depicted) motor 2 at an angular velocity ω and simultaneously moved along a (non-depicted) transport path 6 with a transport means 5 at a speed v. During process step a), the procedure steps b) to d) illustrated below are moreover carried out.

In step b), the container 1 is guided through the image area of an imaging sensor unit 7 for detecting a feature 9 of the container 1 suited for the determination of the rotational position φ of the container 1. The sensor unit 7, which can e.g. comprise one or several cameras, generates measured data M, such as individual camera pictures of the container 1.

In step c), the calculation unit 11 detects the position of the feature 9, such as a molding seam, by means of the measured data M, and on this basis calculates position data L of the container 1 or the support 3, respectively, in particular an actual rotational position φ_{I} of the container 1 or the support 3, respectively, and/or a rotational position correction angle Δφ for the correction from the actual rotational position φ_{I} to a desired rotational position φ_{S} of the container 1.

In step d), the control unit 13 generates and transmits a control signal S for the support 3 and to the motor 2, respectively, for moving the container to the desired rotational position φ_{S} on the basis of the position data L.

In step e), the support 3 is rotated until the container 1 reaches the desired rotational position φ_{S}.

In the embodiment, the container 1 is rotated without interruptions in step a) and during the transition to step e), i.e. the angular velocity ω of the container 1 is advantageously always greater than 0 until the desired rotational position φ_{S} is reached. Thereby, slip in the drive of the support 3 and the involved inaccuracies in the orientation of the rotational position φ can be reduced. Here, rotation without interruptions means a continuous operating mode, which, for example, includes the use of stepper motors.

The angular velocity ω in the desired rotational position φ_{S} is preferably 0. Such a rest position of the rotational position φ is desirable for the rotational position φ to remain unchanged relative to the transport path 6 until a further treatment or test step starts.

However, the latter is not imperative. For example, the angular velocity ω in the desired rotational position φ_{S} could be adapted to a subsequent treatment or test step, such as labeling, to permit a smooth transition in the rotation and thereby eliminate an acceleration ramp.

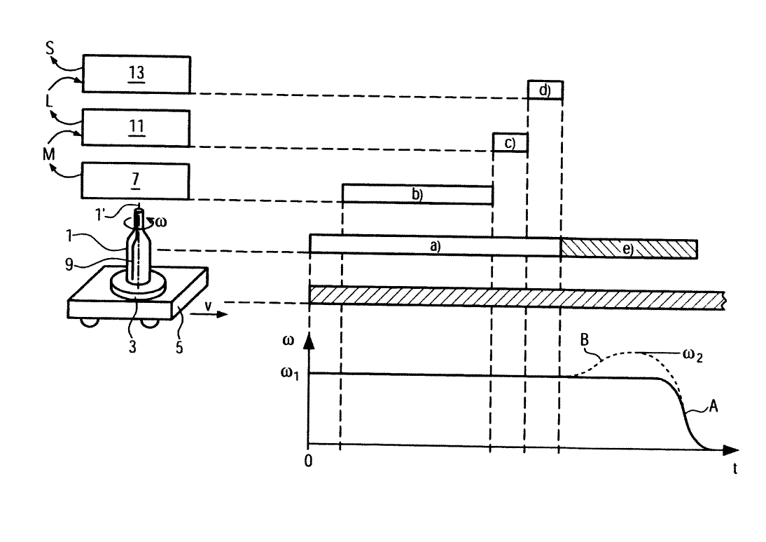

The angular velocity ω of the bottle 1 is in step a), and in particular in step b), essentially constant, as is indicated in FIG. 1 by the value ω₁. However, this is not imperative.

For step e), it is on the one hand conceivable to maintain the angular velocity ω₁ of step a) until the deceleration ramp A is reached at the end of step e) without changes. Thereby, the number of acceleration and deceleration ramps required for reaching the desired rotational position φ_{S} and thus the energy consumption for the rotational position correction are minimized. On the other hand, step e) could comprise an acceleration ramp B up to a maximum angular velocity ω₂, wherein: ω₂>ω₁ to reduce or minimize, respectively, the time required for moving to the desired rotational position φ_{S}. In FIG. 1, this is indicated by the dotted course of the velocity curve. The shown courses of the angular velocity ω are, however, only given by way of example and could also vary in step a) or in steps b), c) and/or d).

It is also possible to adapt the angular velocity ω in step e), in particular the maximum velocity ω₂ and/or an average angular velocity ω₃, to a rotational position correction angle Δφ between the previously calculated actual rotational position φ_{I} and the desired rotational position φ_{S}. Thereby, the rotational position φ can be oriented within a uniform and/or optimal time frame, possibly also independent of the rotational position correction angle Δφ required in each case. The angular velocity ω would only be increased, for example, in greater rotational position correction angles Δφ, if required. This would be a compromise between time and energy savings.

The container 1 rotates about an axis of symmetry of the container 1 in/on the support 3, preferably about its main axis 1′, so that the sensor unit 7 can detect a cylindrical surface area of the container 1 or a similarly suited area, such as e.g. a shoulder of the bottle, over the complete container circumference. The feature 9 can be unevenness on the container surface, such as e.g. an embossment. The feature 9 or several features 9 then necessarily represent(s) an asymmetry, which, however, is irrelevant for the definition of the respective axis of revolution.

As can also be seen in the FIGURE, the container 1 is continuously moved further by the transport means 5, preferably at constant speed v, during steps a) and e), so that a continuous stream of containers can be oriented with respect to the rotational position φ. This is only symbolically indicated in the FIGURE. The transport means 5 can run along a linear or a curved conveyor path 6. In a particularly advantageous variant, the transport means 5 is a transport carousel with supports 3 essentially uniformly distributed around the periphery. The supports 3 usually comprise (non-depicted) centering means for the containers 1.

The collection and transmission of the data M, L, S in steps b) to d) is represented by way of example with reference to the sensor unit 7, the calculation unit 11 and the control unit 13. However, these functions can be arbitrarily distributed to one or several ones of such units. The calculation unit 11 could e.g. also comprise input circuits for video signals and band-pass filters for analyzing image data. The control unit 13 is preferably, though not necessarily, designed as separate apparatus which communicates with the calculation unit 11 via a standardized data channel.

For example, a computer-based camera system could take camera pictures, calculate an actual rotational position φ_{I} therefrom and transfer the calculated data L, possibly with the desired rotational position φ_{S} and/or the rotational position correction angle Δφ, via a CAN bus to a servo control. This could calculate trajectories required for the orientation of the containers 1, possibly taking into consideration a simultaneous movement along the transport path 6, and correspondingly actuate servomotors 2 for driving the supports 3 for one container 1 each. However, other drive systems and motor types would also be conceivable for the support 3.

Equally, though it is desirable, it is not necessary for the steps b), c) and d) to follow each other without any break or overlap, as is represented.

The method according to the disclosure is preferably employed directly upstream of a labeling of the containers 1, e.g. in a labeling machine, however, it is also suited for a combination with other treatment and/or test methods.

Depending on the demand on the accuracy of the orientation, a fine adjustment of the desired rotational position φ_{S} can be performed following step e). For this, normally a new detection of the feature 9 over a small rotational position range as well as calculations and a new movement to the desired rotational position φ_{S} in accordance with steps a) to e) are required. However, the containers can in general also be labeled without any additional fine adjustment.

1. Method for orienting the rotational position of containers, in particular bottles, comprising the following steps:
a) rotating a container to be oriented;
b) detecting a feature on the container;
c) calculating an actual rotational position (φ_{I}) of the container on the basis of the detected feature;
d) calculating a control signal (S) for moving the container to a desired rotational position (φ_{S}); and
e) moving the container to the desired rotational position (φ_{S}),
wherein steps b) to d) are carried out during step a).

2. Method according to claim 1, and rotating the container without interruptions in steps a) to e) until the desired rotational position (φ_{S}) is reached.

3. Method according to claim 1, and stopping the rotation of the container in the desired rotational position (φ_{S}).

4. Method according to claim 1, and rotating the container about its main axis.

5. Method according to claim 1, and rotating the container in step e) to a deceleration ramp at essentially the same angular velocity (ω₁) as in step a).

6. Method according to claim 1, and rotating the container in step e) at least temporarily at a higher angular velocity (ω₂) than in step a).

7. Method according to claim 6, and adapting the angular velocity (ω₂) to a rotational position correction angle (Δφ) in step e).

8. Method according to claim 1, and detecting the feature on the container by imaging.

9. Method according to claim 1, and moving the container along a transport path during steps a) to e).

10. Method for labeling containers, comprising:
a) to e) orienting the containers according to claim 1; and
g) labeling the containers.

11. Method for labeling containers according to claim 10, and readjusting the rotational position (φ) of the container in a step f) inserted between steps e) and g).

12. Device for carrying out the method according to claim 1, comprising:
at least one rotatable support with a motor for rotating a container to be oriented;
at least one imaging sensor unit for detecting a feature on the container;
a calculation unit for calculating an actual rotational position (φ_{I}) of the container on the basis of the detected feature; and
a control unit for actuating the motor, wherein the control unit is designed such that it calculates and outputs a control signal for moving the container to a desired rotational position (φ_{S}) while the motor is operated.

13. Device according to claim 12, wherein the motor is a servomotor.

14. Device according to claim 12, and a transport means which moves the container along a predetermined transport path during the orientation of its rotational position (φ).

15. Labeling machine with a device according to claim 12.
